(19) United States
(12) Patent Application Publication
(10) Pub. No.: US 2026/0063032 A1
(43) Pub. Date: Mar. 5, 2026

(54) A SYSTEM FOR INVESTIGATING THE CONDITION OF A TUBULAR STRING

(71) Applicant: Tamas BOZSO, Kecskemet (HU)

(72) Inventor: Tamas BOZSO, Kecskemet (HU)

(21) Appl. No.: 19/101,697

(22) PCT Filed: Sep. 2, 2023
(86) PCT No.: PCT/IB2023/000527

§ 371 Date: Feb. 6, 2025

(30) Foreign Application Priority Data
Sep. 3, 2022 (US) 63403731

(51) Int. Cl. E21B 47/09; E21B 47/024; G01D 5/20

(52) U.S. Cl. CPC E21B 47/09; E21B 47/024; G01D 5/20

(57) ABSTRACT

A system for determining the condition of a tubular string comprising an elongate body connectable to an elongate conduit, a data storage device, an inclination sensor, a plurality of inductive distance sensors, each to generate a signal indicating the distance from the sensor to an interior wall of a bore of a tubular string in which the body is positioned, an accelerometer and an electrical power storage source coupled to each of the inductive sensors, the inclination sensor and the accelerometer, wherein signals generated by the plurality of inductive distance sensors can be correlated with the position of the body within the bore of the tubular string to determine the ovality of the bore of the tubular string adjacent to the plurality of inductive distance sensors and a build-up of scale on the interior surface of the bore of the tubular string adjacent to the plurality of inductive distance sensors.

### STATEMENT OF RELATED APPLICATIONS

This application depends from and claims priority to U.S. Provisional Application No. 63/403,731 filed on Sep. 3, 2022.

### BACKGROUND

### Field of the Invention

The present invention relates to tools used to investigate downhole conditions existing in a borehole drilled into the earth's crust. More specifically, the present invention relates to tools used to obtain an impression of an obstruction within a tubular string in a borehole drilled into the earth's crust.

### Background of the Related Art

Tubular pipe strings are commonly used in oil and gas drilling and production. For example, but not by way of limitation, a drilling assembly having a bit thereon can be coupled to a distal end of a drill string made of tubular pipe. The tubular pipe string can be used to position the drilling assembly within an earthen borehole and the tubular pipe can be rotated and advanced into the earthen borehole to extend the borehole into the earth's crust. Subsequently, a tubular pipe string can be installed as casing to isolate the borehole and to stabilize the borehole against collapse. Also, a tubular pipe string can be installed within the bore of a casing string and used to produce fluids residing in subsurface geologic formations to the surface or to inject fluids from the surface into subsurface geologic formations.

Inspection and repair of tubular pipe strings is critical to the continued utilization of the borehole in which the tubular pipe strings are used. Various tools and methods have been developed to enable operators to detect and repair problems that may occur in the borehole such as, for example, and not by way of limitation, leaks due to corrosion, obstacles lodged in the bore of a tubular string, deformation or collapse of the tubular string, scale formation within the bore of the tubular string, etc. These tools and methods can be used to determine the nature and character of the problems and the location of the problem within the borehole. Operators can then use the information obtained using these diagnostic tools to prepare and implement a workover or other well operation to remediate the problem.

### BRIEF SUMMARY

One embodiment of the present invention provides a system for investigating the condition of a tubular string in an earthen borehole includes an elongate body having a proximal end, a distal end, a center axis extending through the proximal end and the distal end, a connector coupled to the proximal end of the body to couple the body to a distal end of an elongate conduit that can be used to position the body within a bore of a tubular string, an inclination sensor coupled to the data storage device to detect and to generate a signal indicating an angle of the center axis of the body relative to gravity, a plurality of angularly distributed inductive distance sensors coupled to the data storage device, each of the plurality of inductive distance sensors to generate a signal indicating the distance from the inductive distance sensor to an interior wall of a bore of a tubular string in which the body is positioned, and an accelerometer coupled to the data storage device to generate a signal indicating the acceleration of the body. The embodiment of the system further includes a data storage device to receive and store signals generated by sensors disposed on or within the body and an electrical power source coupled to each of the plurality of inductive sensors, the inclination sensor, the accelerometer. In some embodiments, the data storage device and/or the electrical power source may be disposed within the elongate body with the accelerometer, the inductive distance sensors and the inclinometer, and in other embodiments, the data storage source and/or the electrical power source may be disposed at the surface and connected to the plurality of inductive sensors, the inclination sensor and the accelerometer through the conduit that is used to position the elongate body within the bore of the tubular pipe string under investigation.

The elongate conduit used to position the elongate body within the bore of the tubular pipe string under investigation may comprise a slickline, an e-line, drill pipe, a coiled tubing or other conduit for connecting the elongate body to instruments and equipment at the surface. The proximal end of the elongate conduit may be coupled to a storage reel at the surface that is coupled to a wench and thereby driven to rotate to spool out and reel in the conduit and position the elongate body within the tubular pipe string. The position of the elongate body within the bore of the tubular pipe string under investigation can be determined by measuring the length of the conduit that is inserted into the proximal end of the bore of the tubular string under investigation. In one embodiment, the proximal end of the elongate conduit may be coupled to a downhole tractor that is adapted for controllable movement within the bore of the tubular pipe string to position the elongate body.

The plurality of inductive distance sensors are disposed within the elongate body, preferably within a portion of the elongate body that is of a material that is compatible with the creation of a magnetic field and with the measurement of changes within a magnetic field generated by the inductive distance sensor due to eddy currents that are developed on a conductive surfaces, such as the interior wall of the bore of the tubular pipe string under investigation. In one embodiment, each of the plurality of inductive distance sensors are angularly separated one from the others within the elongate body and aimed radially outwardly from the center axis thereof. In one embodiment, each of the plurality of inductive distance sensors is equi-angularly separated one from the others and aimed radially outwardly from the center axis thereof to provide an angular zone of investigation for each of the plurality of inductive distance sensors that is associated with one of the plurality of inductive distance sensors. In one embodiment, each of the plurality of inductive distance sensors is connected to a dedicated line through which data generated by that inductive distance sensor can be transmitted to a data storage device and/or to a processor. In another embodiment, each of the plurality of inductive distance sensors can be programmed to deliver signals along with a unique identifier signal that identifies the specific one of the plurality of inductive distance sensors from which the signal was generated. In embodiments of the system of the present invention, the plurality of inductive distance sensors each provide signals that enable the position of the plurality of inductive distance sensors relative to the interior wall of the bore of the tubular string under investigation to be determined. These signals can be compared and correlated one to the others, and all or some to the known dimensions of the tubular pipe string (depth as determined by the length of the conduit used to position the body, wall thickness, diameter, etc.), to determine the physical condition of the tubular pipe string at a location of interest. The results of the comparison and the correlation enables an operator to engineer and implement and effective workover or other wellbore modifications to correct any problematic conditions that may be discovered using the system.

Embodiments of the system of the present invention, along with information relating to the original installation of the tubular pipe string and information relating to any repairs or modifications thereto, enable an operator to determine the character and nature of the condition of the tubular pipe string at a location of interest including, for example, but not by way of limitation, the collapse and/or ovality of the tubular pipe string, holes or perforations in the tubular pipe string, missing pipe sections or portions of the tubular pipe string, corrosion of the tubular pipe string, parted portions of the tubular pipe string, scale deposition on the interior wall of the tubular pipe string and obstructions caused by unwanted articles becoming lodged in the bore of the tubular pipe string. An incline sensor generates a signal indicating the inclination of a center axis of the body relative to gravity at a location of interest, an accelerometer generates a signal indicating the acceleration or deceleration to which the body is exposed at a location of interest, and a plurality of inductive distance sensors generate signals indicating the distance from the body to the interior wall of the bore of the tubular string adjacent to each of the plurality of inductive distance sensors.

In one embodiment of the system of the present invention, the elongate body includes a non-ferrous portion that surrounds the plurality of angularly arranged and separated inductive distance sensors to promote the capacity of each of the plurality of inductive distance sensors to generate an electromagnetic field intermediate the inductive distance sensor and the interior wall of the tubular pipe string at the location of interest. The non-ferrous portion of the elongate body may, in one embodiment, be a ceramic sleeve. The non-ferrous portion may be sized and shaped for being sealable coupled axially intermediate a proximal portion of the elongate body and a distal portion of the elongate body.

In one embodiment of the system of the present invention, the elongate body is sealed to prevent intrusion of well fluids that might impair the function of the sensors and components of the system that are housed within the elongate body.

In one embodiment of the system of the present invention, the sensors, which includes the accelerometer, the inclinometer and the plurality of inductive distance sensors, are each coupled via conductive wire to transmit signals to a processor and/or a data storage device, and the source of electrical power is similarly coupled to the sensors and/or the processor and/or the data storage device via conductive wire. In other embodiments of the system of the present invention, some of the components and/or sensors are wirelessly coupled using transmitters and receivers such that signals generated by, for example, but not by way of limitation, the inclinometer, the accelerometer and/or the plurality of inductive distance sensors can be wirelessly provided to the processor and/or the data storage device.

In one embodiment of the system of the present invention, a data port may be included on the elongate body to permit the downloading of data stored on the data storage device from the data storage device to a receiver that is either placed in close proximity to the data port or otherwise connected. For example, but not by way of limitation, the data port may be a sealed and transparent window or lens through which optical data can be passed from the data storage device to an optical data receiver placed in close proximity to the data port. In another example, again not by way of limitation, a sealed fiber optic or conductive socket may be provided at the data port to optically or conductively transmit data stored on the data storage device through the data port and through a cable (fiber optic or conductive) that is plugged into or otherwise docked with the data port.

In one embodiment of the system of the present invention, the processor may condition the signals received from one or more of the plurality of inductive sensors, the accelerometer and the inclination sensor in a manner that makes the data visually observable in a graphic format. For example, but not by way of limitation, the processor may be programmed for conditioning the signals prior to or after storage on the data storage device to provide the signals and the data related thereto in a digital, analog or optical condition suitable for display on an electronic display screen such as, for example, but not by way of limitation, a cathode ray tube, a light-emitting diode screen, a liquid crystal display screen, etc. The data may be conditioned, in one embodiment, to condition the data and to provide the data to a display device in a manner that simulates the position of the cross-section of the elongate body, which may be circular, within the bore of the tubular pipe string, as is shown on FIGS. 4-7 to be discussed in more detail below.

In one embodiment of the system of the present invention, the inclinometer, the accelerometer and the plurality of inductive distance sensors are disposed within the elongate body and the processor, the data storage device and the source of electrical current remain at the surface of the earthen borehole connected to the proximal end of the conduit and are coupled to the inclinometer, the accelerometer and the plurality of inductive distance sensors through conductive elements such as wires in the conduit that is used to connect to the proximal end of the elongate body and position the body within the bore of the tubular pipe string. It will be understood that one or all of the processor, the data storage device and the source of electrical current can remain at the surface of the earthen borehole into which the tubular pipe string under investigation is installed, with the others, if any, being disposed within the elongate body with the inclinometer, the accelerometer and the plurality of inductive distance sensors.

In one embodiment of the system of the present invention, a deformable lead impression block is coupled to the distal end of the elongate body and a load cell is disposed intermediate the lead impression block and the elongate body to generate a signal to one or both of the data storage device and the processor upon sensing a load or force applied against the lead impression block engagement with an obstruction to further movement of the body within the bore of the tubular pipe string.

In one embodiment of the system of the present invention, a jetting tool may be coupled to the distal end of the elongate body and a fluid conduit or a series of fluid conduits supply high pressure fluid from the surface of the earthen borehole in which the tubular pipe string is installed through the conduit used to position the elongate body within the bore of the tubular pipe string, through a conduit within the elongate body and to the jetting tool coupled to the distal end of the elongate body to enable the jetting tool to erode, clean or to cut an obstacle within the bore of the tubular pipe string or to remove scale deposits detected using the system.

In one embodiment of the system of the present invention, a bottomhole drilling assembly, a gauge cutter, a drift tool or a sub can be coupled to the distal end of the elongate body. In one embodiment of the system of the present invention having a bottom hole drilling assembly coupled to the distal end of the elongate body, electrical current or pressurized power fluid may be provided to the bottomhole drilling assembly using a conduit or a series of conduits connected to an electrical current source or a source of pressurized power fluid at the surface of the earthen borehole by an electrical conductor element or a fluid conduit within the conduit used to position the elongate body within the bore of the tubular pipe string and a conduit, connected in series to the fluid conduit, to deliver the electrical current or the power fluid through the elongate body to the bottomhole assembly.

The discussion above discloses that the conduit used to position the elongate body of the embodiment of the system within the bore of the tubular pipe string can include a plurality of smaller conduits, including, but not limited to, fluid conduits for delivering pressurized fluid to the elongate body, conduits that conduct electrical current from an electrical current source to the elongate body and/or optical cables or fibers that carry signals in the form of light energy, etc. In some embodiments, two or more of these different types of smaller conduits may be used together in a conduit that can be used to position the elongate body within the bore of the tubular pipe string.

The signals generated by the accelerometer, the inclinometer and the plurality of inductive distance sensors are processed and/or stored in the data storage device and correlated with other data relating to the physical condition of the tubular pipe string under investigation. Original data relating to the tubular pipe string such as, for example, the location of pipe connections, the depth and orientation of components of the tubular pipe string such as gas lift injection mandrels, open or closed position of sliding side doors, subs, collars, and to the structure of the tubular pipe string including thickness, inner diameter, material, etc. can be correlated with the data obtained through the signals generated by the sensors to determine the condition of the tubular pipe string at a location of interest. For example, but not by way of limitation, signals from the accelerometer generated during advancement of the elongate body within the bore of the tubular pipe string may be correlated with signals generated by the plurality of inductive distance sensors to confirm either collapse or corrosion of the tubular pipe string impairing or impeding the movement of the elongate body.

### BRIEF DESCRIPTION OF THE SEVERAL VIEWS OF THE DRAWINGS

FIG. 1 is an elevation view of an embodiment of a system of the present invention including an elongate body being positioned within a tubular pipe string installed in an earthen borehole by feeding in and withdrawing a conduit stored on a rotatable reel.

FIG. 2 is an elevation view of an elongate body connectable at its proximal end to a distal end of a conduit that is a part of an embodiment of a system of the present invention.

FIG. 3 is a sectional view of the elongate body showing one angularly distributed arrangement of a plurality of inductive distance sensors that have the capacity to generate a plurality of angularly distributed electromagnetic fields around the elongate body.

FIG. 4 is a sectional view of the angularly distributed arrangement of a plurality of inductive distance sensors within the elongate body of an embodiment of a system of the present invention and positioned within the bore of a tubular pipe string and illustrating the interactions of the plurality of angularly distributed electromagnetic fields generated by the plurality of inductive distance sensors of the elongate body of an embodiment of the system of the present invention with the tubular pipe string at a location of interest.

FIG. 5 is a sectional view of the angularly distributed arrangement of a plurality of inductive distance sensors within the elongate body of an embodiment of a system of the present invention and positioned within the bore of a tubular pipe string having a corroded portion of the tubular pipe string missing and illustrating the interactions of the plurality of angularly distributed electromagnetic fields generated by the plurality of inductive distance sensors of the elongate body of an embodiment of the system of the present invention with the tubular pipe string at a location of interest.

FIG. 6 is a sectional view of the angularly distributed arrangement of a plurality of inductive distance sensors within the elongate body of an embodiment of a system of the present invention and positioned within the bore of a tubular pipe string having a scaled portion of the tubular pipe string intermediate the elongate body and the interior wall of the tubular pipe string and illustrating the interactions of the plurality of angularly distributed electromagnetic fields generated by the plurality of inductive distance sensors of the elongate body of an embodiment of the system of the present invention with the tubular pipe string at a location of interest.

FIG. 7 is a sectional view of the angularly distributed arrangement of a plurality of inductive distance sensors within the elongate body of an embodiment of a system of the present invention and positioned within the bore of a tubular pipe string having a collapse portion of the tubular pipe string and illustrating the interactions of the plurality of angularly distributed electromagnetic fields generated by the plurality of inductive distance sensors of the elongate body of an embodiment of the system of the present invention with the tubular pipe string at a location of interest.

FIG. 8 is a diagram indicating the electronic interactions of some of the components of an embodiment of a system of the present invention.

### DETAILED DESCRIPTION

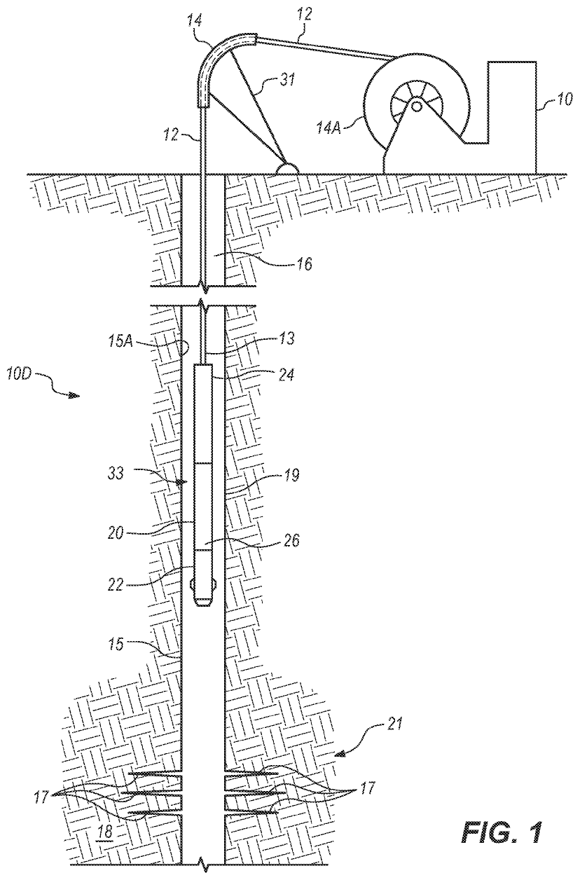

FIG. 1 is an elevation view of an embodiment of a system 100 of the present invention including an elongate body 20 being positioned within a bore 16 of a tubular pipe string 15 installed in an earthen borehole 19 by feeding in and withdrawing a conduit 12 stored on a rotatable reel 14A and having a distal end 13 coupled to a proximal end 24 of the elongate body 20. The tubular pipe string 15 includes an interior wall 15A that surrounds the bore 16. The earthen borehole 19 is drilled into the earth's crust 18 to access an oil and/or gas bearing subsurface geologic formation 21 into which perforations have been created to enhance production rates. A tool 22 such as, for example, but not by way of limitation, jetting tool, a bottomhole drilling assembly, a gauge cutter, a lead impression block, or some other downhole tool can be coupled to the distal end 26 of the elongate body 20. The rotatable reel 14A is rotatably secured to a workover rig 10 or some other piece of equipment for supporting the reel 14A. The conduit 12 is shown to be passed over a pulley or conduit guide 14 that is supported by a brace 31 proximal to the earthen borehole 19. The elongate body 20 is smaller in diameter than the bore 16 of the tubular pipe string 15 thereby creating an annulus 33 that surrounds the elongate body 20.

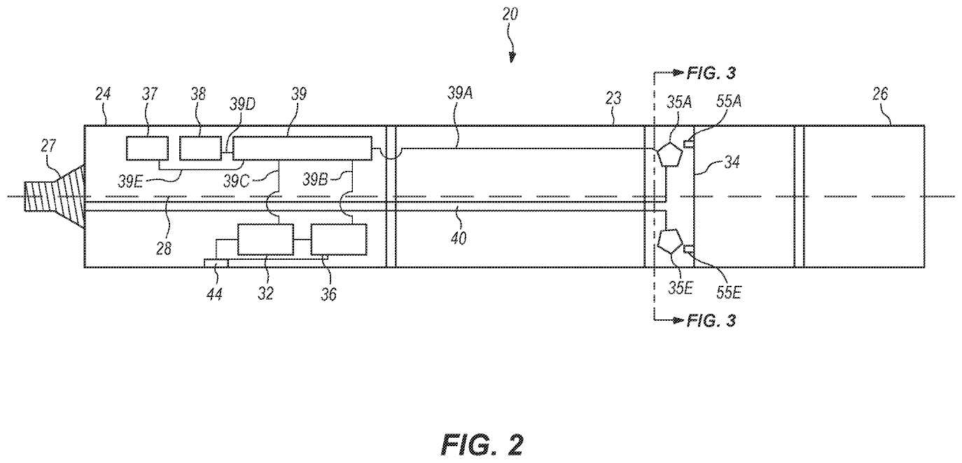

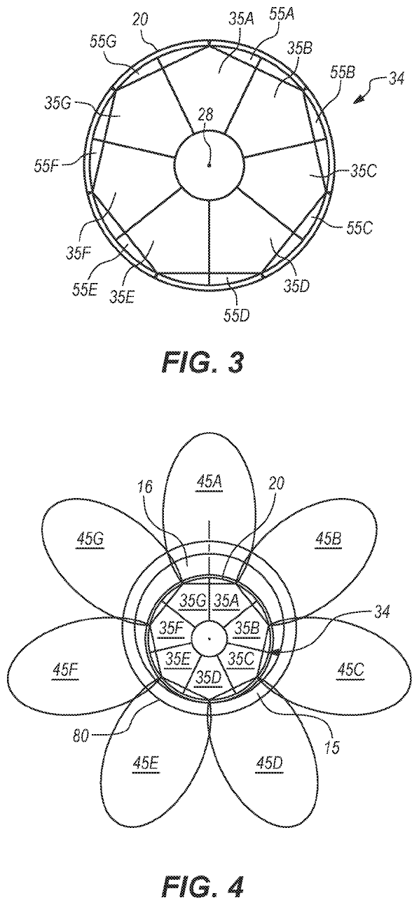

FIG. 2 is an elevation view of an elongate body 20 of an embodiment of a system of the present invention, the elongate body 20 being connectable at its proximal end 24 to a distal end 13 (not shown in FIG. 2) of a conduit 12 that is a part of an embodiment of a system of the present invention. The elongate body 20 has a center axis 28 that passes through the proximal end 14 and the distal end 26. The elongate body 20 further includes a connector 27 at the proximal end 26, an accelerometer 37, an inclinometer 38, an electrical power storage device 39 (such as, for example, a battery or a fuel cell), a processor 36, a data storage device 32 and an inductive sensor 34 having a plurality of inductive distance sensors 35A-35G (not all shown in FIG. 2—see FIG. 3-7). A data port 44 is provided to enable data stored in the data storage device 32 and/or signals or conditioned signals from the processor 36 to be downloaded directly from the body 20 via an optical or conductive connector plug (not shown). FIG. 2 illustrates how wires 39A, 39B, 39C, 39D and 39E may be used to provide electrical current to the plurality of inductive distance sensors 35A-35G, the processor 36, the data storage device 32, the inclinometer 38 and the accelerometer 37, respectively. In an alternate embodiment, each of these electrical current consuming components and sensors may be connected to a dedicated source of electrical currents. In one embodiment, a wire bundle 40 is a plurality of wires equal in number to the plurality of inductive distance sensors 35A-35G to carry signals generated by each of the plurality of inductive distance sensors 35A-35G. In one embodiment, the inductive distance sensors 35A-35G are surrounded by a non-ferrous portion 23 of the elongate body 34. The non-ferrous portion 23 may comprise, in one embodiment of the system of the present invention, a ceramic portion. FIG. 2 shows only two of seven inductive distance sensors included in this particular embodiment of the system of the present invention, and only two are shown in FIG. 2 for simplicity. In one embodiment, the elongate body 34 includes a plurality of temperature sensors 55A-55G, each of the plurality of temperature sensors 55A-55G disposed in a position to detect the temperature of one or more of the plurality of inductive distance sensors 35A-35G. Alternately, a single temperature sensor could be disposed in a position to detect the temperature of the plurality of inductive distance sensors 35A-35G.

FIG. 3 is a sectional view of the inductive sensor 34 of the elongate body 20 showing one angularly distributed arrangement of a plurality of inductive distance sensors 35A-35G that have the capacity to generate a plurality of angularly distributed electromagnetic fields (not shown) around the elongate body 20. The inductive sensor 34 of FIG. 3 has seven inductive distance sensors 35A-35G in an angularly distributed arrangement, thereby providing each of the inductive distance sensors 35A-35G with about 51 degrees (0.9 radians) of span for each of the inductive distance sensors 35A-35G. The inductive distance sensors 35A-35G are shown angularly distributed around the center axis 28 of the elongate body 20. Each of the plurality of inductive temperature sensors 35A-35G is shown as being positioned in close proximity to one of the plurality of inductive distance sensors 55A-55G. Each of the plurality of temperature sensors 55A-55G generates a signal indicating the temperature of the inductive distance sensor that is adjacent to or in contact with the temperature sensor. The plurality of signals generated by the temperature sensors 55A-55G can be received by the processor and used to correct or to compensate the signals obtained using the plurality of inductive distance sensors 35A-35G.

FIG. 4 is a sectional view of the inductive sensor 34 with the angularly distributed arrangement of a plurality of inductive distance sensors 35A-35G within the elongate body 20 of an embodiment of a system of the present invention and positioned within the bore 16 of a tubular pipe string 15. FIG. 4 illustrates the interactions of the plurality of angularly distributed electromagnetic fields 45A-45G generated by the plurality of inductive distance sensors 35A-35G, respectively, of the elongate body 20 of an embodiment of the system of the present invention with the tubular pipe string 15 at a location of interest. FIG. 4 shows that the tubular pipe string 15 is not collapsed, damaged or corroded, and it does not include a deposit of scale or other material within the bore 16 of the tubular pipe string 15.

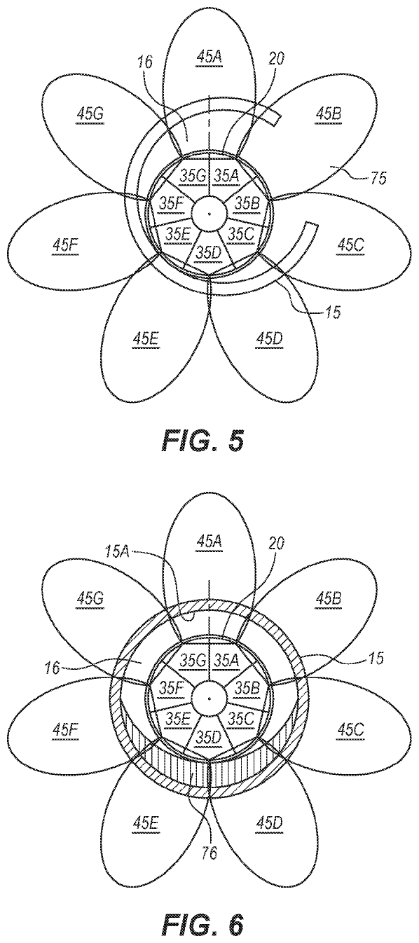

FIG. 5 is a sectional view of the angularly distributed arrangement of a plurality of inductive distance sensors 35A-35G within the elongate body 20 of an embodiment of a system of the present invention and positioned within the bore 16 of a tubular pipe string 15 having a corroded and missing portion (not shown) of the tubular pipe string 15, the missing portion formerly being at the location of the tubular pipe string 15 indicted by the reference numeral 75. The missing portion of the tubular pipe string 15 is adjacent to inductive distance sensors 35B and 35C. It will be understood that while inductive distance sensors 35A and 35D-35G will generate signals within a normal range to indicate the distance from each of these distance sensors 35D-35G, the inductive distance sensors 35B and 35C will generate no signals or signals that are outside the normal range and thereby will indicate not only the missing section of the tubular pipe string 15.

FIG. 6 is a sectional view of the angularly distributed arrangement of a plurality of inductive distance sensors 35A-35G within the elongate body 20 of an embodiment of a system of the present invention and positioned within the bore 16 of a tubular pipe string 15 having a scaled portion 76 of the tubular pipe string 15 intermediate the elongate body 20 and the interior wall 15A of the tubular pipe string 15 and illustrating the interactions of the plurality of angularly distributed electromagnetic fields 45A-45G generated by the plurality of inductive distance sensors 35A-35G of the elongate body 20 of an embodiment of the system of the present invention with the tubular pipe string 15 at a location of interest. The scaled portion 76 is an accumulated deposit of scale on the interior wall 15A and within the bore 16 of the tubular pipe string 15 and can be detected by correlating the signals generated by the plurality of inductive distance sensors 35A, 35D and 35E and the distances from the center axis 28 to the interior wall 15A of the tubular pipe string 15 through each of the plurality of inductive distance sensors 35A, 35D and 35E. In the configuration illustrated in FIG. 6, the distances detected by inductive distance sensors 35A, 35D and 35E will indicate an inner diameter that is consistent with the known inner diameter of the tubular pipe string 15 when installed and the distances indicated by inductive sensors 35D and 35E, along with the signals generated by the inclinometer (not shown), will indicate the presence of scale deposition 76 preventing the body 20 from resting against the bottom of the tubular pipe string 15 and supported intermediate the center axis 28 and the interior wall 15A of the tubular pipe string 15.

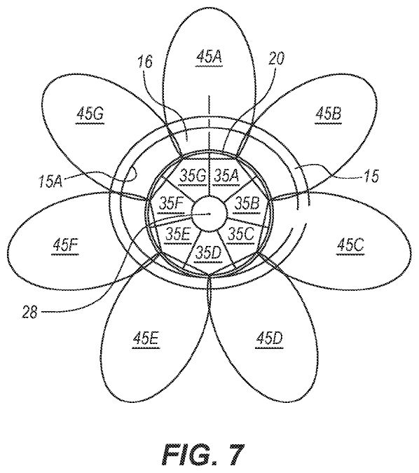

FIG. 7 is a sectional view of the angularly distributed arrangement of a plurality of inductive distance sensors 35A-35G within the elongate body 20 of an embodiment of a system of the present invention and positioned within the bore 16 of a tubular pipe string 15 at a collapsed portion of the tubular pipe string 15 and illustrating the interactions of the plurality of angularly distributed electromagnetic fields 45A-45G generated by the plurality of inductive distance sensors 35A-35G of the elongate body 20 of an embodiment of the system of the present invention with the tubular pipe string 15 at a location of interest. The ovality of the collapsed portion of the pipe 15 can be detected by correlating the signals generated by the plurality of inductive distance sensors 35A-35G and the distances from the center axis 28 to the interior wall 15A of the tubular pipe string 15 through each of the plurality of inductive distance sensors 35A-35G. In the configuration illustrated in FIG. 7, the distances detected by inductive distance sensors 35A, 35D and 35G will indicate an inner diameter that is less than the known inner diameter of the tubular pipe string 15 when installed and the distances indicated by inductive sensors 35B, 35C, 35F and 35G will indicate an inner diameter that is more than the known inner diameter of the tubular pipe string 15 when installed.

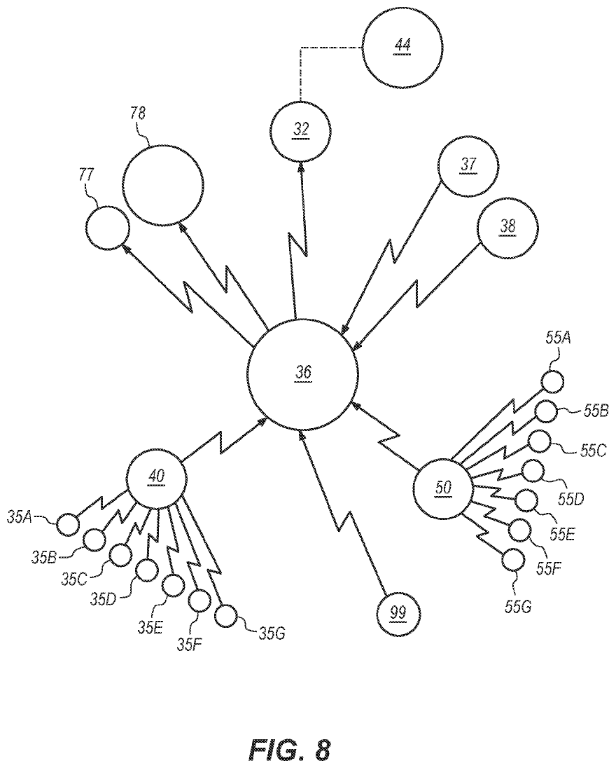

FIG. 8 is a diagram illustrating the interactions of the components and sensors of the embodiment of a system of the present invention. In the central portion of FIG. 8 is the processor 36, which is shown to be receiving signals (indicated by jagged lines) from the accelerometer 37, the inclinometer 38, the plurality of temperature sensors 55A-55G and the plurality of inductive distance sensors 35A-35G. Additional conditions such as, for example, but not by way of limitation, the downhole pressure may also be measured by an additional sensor 99 which generates a signal to the processor 36 corresponding to the measured pressure or, alternately, some other downhole condition. The processor 36 may, in one embodiment, be used to process and condition incoming signals and generating input to display devices 77 and 78 and/or to deliver data to the data storage device 32. Data stored on the data storage device 32 may, in one embodiment, be downloaded from the data storage device 32 to an optical port 44.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for determining the condition of a tubular string, comprising:
an elongate body having a proximal end, a distal end and a center axis extending through the proximal end and the distal end;
a connector coupled to the proximal end of the body to couple the body to a distal end of an elongate conduit that can be used to position the body within a tubular string;
a data storage device to receive and store signals generated by sensors disposed on or within the body;
an inclination sensor coupled to the data storage device to detect and to generate a signal indicating an angle of the center axis of the body relative to gravity;
a plurality of angularly distributed inductive distance sensors coupled to the data storage device, each of the plurality of inductive distance sensors to generate a signal indicating the distance from the inductive distance sensor to an interior wall of a bore of a tubular string in which the body is positioned;
an accelerometer coupled to the data storage device to generate a signal indicating the acceleration of the body; and
an electrical power storage source coupled to each of the plurality of inductive sensors, the inclination sensor, the accelerometer;
wherein the length of the conduit fed into the bore of the tubular string can be used to determine the position of the body within the bore of the tubular string;
wherein the signals generated by the plurality of inductive distance sensors can be correlated with the position of the body within the bore of the tubular string to determine the ovality of the bore of the tubular string adjacent to the plurality of inductive distance sensors and a build-up of scale on the interior surface of the bore of the tubular string adjacent to the plurality of inductive distance sensors;
wherein the signals generated by the accelerometer can be correlated with the position of the body within the bore of the tubular string to determine of an obstruction that impedes smooth movement of the body through the bore of the tubular string; and
wherein signals generated by the inclination sensor can be correlated with the signals generated by the plurality of inductive distance sensors to determine whether a separation of the body from the interior surface of the tubular string is due to scale.

2. The system of claim 1, further comprising:
a processor coupled to one or more of the data storage device, the inclination sensor, the plurality of inductive distance sensors, the accelerometer and the electrical power storage source.

3. The system of claim 2, wherein the processor conditions the signals received from one or more of the plurality of inductive sensors, the accelerometer and the inclination sensor for display on a display screen.

4. The system of claim 1, further comprising:
a transmitter coupled to the data storage device and the electrical power storage source, the transmitter adapted for wirelessly transmitting data stored on the data storage device to a receiving device.

5. The system of claim 1, wherein the plurality of inductive sensors, the accelerometer and the inclination sensor are each within the body and are each coupled to the data storage device through the conduit, the data storage device being coupled to a proximal end of the conduit.

6. The system of claim 1, wherein the plurality of inductive sensors, the accelerometer and the inclination sensor are each within the body and are each coupled to the source of electrical current through the conduit, the source of electrical current being coupled to a proximal end of the conduit.

7. The system of claim 1, wherein a portion of the body surrounding the plurality of inductive distance sensors comprises ceramic.

8. The system of claim 1, further comprising:
a load cell disposed proximal to a deformable lead impression block coupled to the distal end of the body to generate a signal to the data storage device upon sensing a load against the lead impression block caused by an obstruction to movement of the body within the bore of the tubular string.

9. The system of claim 1, wherein the connector coupled to the proximal end of the body to couple the body to a distal end of an elongate conduit that can be used to position the body within a tubular string includes a plurality of electrical contacts to engage distal ends of a plurality of electrical wires within the conduit.

10. The system of claim 1, further comprising:
one of an impression block having a deformable face thereon, a gauge cutter, a drift tool, a bottomhole assembly, a drill assembly, a jetting too and a sub removably coupled to the distal end of the body.
